(19) United States
(12) Patent Application Publication
(10) Pub. No.: US 2004/0214085 A1
(43) Pub. Date: Oct. 28, 2004

(54) Negative active material for rechargeable lithium battery, method of preparing same, and rechargeable lithium battery

(76) Inventors: Kyou-Yoon Sheem, Ohsan-city (KR); Keiko Matsubara, Yokohama-shi (JP); Toshiaki Tsuno, Yokohama-shi (JP); Akira Takamuku, Yokohama-shi (JP)

Correspondence Address: CHRISTIE, PARKER & HALE, LLP, PO BOX 7068, PASADENA, CA, 91109-7068, US

(21) Appl. No.: 10/752,300

(22) Filed: Jan. 6, 2004

(30) Foreign Application Priority Data
Jan. 6, 2003 (JP) 2003-446
Jan. 5, 2004 (KR) 2004-262

(51) Int. Cl. H01M 4/40; H01M 4/58

(52) U.S. Cl. 429/218.1; 429/221; 429/223; 429/220; 429/231.95; 429/231.5; 252/182.1

(57) ABSTRACT

Disclosed is a negative active material for a lithium rechargeable battery which includes an aggregate of Si porous particles, wherein the porous particles are formed with a plurality of voids therein, wherein the voids have an average diameter of between 1 nm and 10 μm, and the aggregate has an average particle size of between 1 μm and 100 μm.

### CROSS REFERENCE TO RELATED APPLICATION

This application claims priority of Japanese application No. 2003-446 filed in the Japan Patent Office on Jan. 6, 2003, and Korean application No. 2004-262 Korean Intellectual Property Office on Jan. 5, 2004, the entire disclosures of which are incorporated hereinto by reference.

### FIELD OF THE INVENTION

The present invention relates to a negative active material for a rechargeable lithium battery, a method of preparing the same, and a rechargeable lithium battery comprising the same.

### BACKGROUND OF THE INVENTION

Although research to develop a negative active material having a high capacity based on metallic materials such as Si, An, and Al has actively been undertaken, such research has not yet succeeded in applying said metals to a negative active material. This is mainly due to the problems of cycle characteristics being degenerated by a series of processes of intercalating and deintercalating lithium ions with metals such as Si, Sn, and Al, and consequential expansion and contraction of the volume thereof, which pulverizes the metal.

In order to attempt to solve these problems, an amorphous metal has been suggested in laid-open Japanese Patent Publication No. 2002-216746, and a crystalline alloy such as a Ni/Si-based alloy consisting of a metal capable of alloying with lithium and a metal incapable of alloying with lithium was put forth in the proceedings of the 42^{nd} Battery Symposium in Japan (The Electrochemical Society of Japan, The Committee of Battery Technology, Nov. 21, 2001, p. 296-327) and forth in the proceedings of the 43^{nd} Battery Symposium in Japan (The Electrochemical Society of Japan, The Committee of Battery Technology, Oct. 12, 2002, p. 326-327.)

However, the aforementioned cause problems in that the capacity per unit weight of the alloy decreases on charging and discharging of the battery when the crystalline alloy and the amorphous alloy includes metal incapable of alloying with lithium or the metal, and even if they are capable of alloying with lithium, they produce an intermetal compound of low capacity. Further, when such an alloy is adapted in the form of a powder, the average particle size thereof is relatively large, and thereby the metal tends to be pulverized due to expansion and contraction of the volume of the alloy upon charging and discharging the battery, and the alloy easily peels off from the current collector. Additionally, problems are caused because the alloy is hard to bind to the conductive material.

### SUMMARY OF THE INVENTION

It is an aspect of the present invention to provide a negative active material capable of preventing pulverization of the active material and peeling of the active material from the current collector.

It is another aspect of the present invention to provide a lithium rechargeable battery including the same.

It is still another aspect of the present invention to provide a method of preparing the same, and a lithium rechargeable battery including the same.

In order to achieve these results, the present invention provides a negative active material for a lithium rechargeable battery including an aggregate of Si porous particles, wherein the porous particles are formed with a plurality of voids having an average diameter of between 1 nm and 10 μm, and the aggregate has an average particle size of between 1 μm and 100 μm.

These and other aspects may be achieved by a rechargeable lithium battery including a negative electrode, a positive electrode and an electrolyte. The negative electrode includes the negative active material.

The present invention further includes quenching a molten metal alloy including Si and at least one kind of an element M to provide a quenched alloy; and eluting and removing the element M included in the quenched alloy with an acid or an alkali capable of dissolving the element M to provide an aggregate of porous particles including Si.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, wherein:

FIG. 1 is a cross-sectional schematic view showing a porous particle of a negative active material for a lithium rechargeable battery according to one embodiment of the present invention;

FIG. 2 is a cross-sectional schematic view showing a porous particle of a negative active material for a lithium rechargeable battery according to another embodiment of the present invention; and

FIG. 3 illustrates a lithium battery using the negative active material of the present invention.

### DETAILED DESCRIPTION OF THE INVENTION

The negative active material according to the present invention includes an aggregate of porous silicon particles, wherein the porous particles are formed with a plurality of voids having an average diameter of between 1 nm and 10 μm, and the aggregate has an average particle size of between 1 μm and 100 μm.

Since the negative active material for the lithium rechargeable battery includes porous particles having a plurality of voids therein, it can prevent pulverization of the porous particles. The external volume of the porous particles is maintained by compressing the volume of the void when the volume is expanded during the process of intercalating lithium ions with Si.

Specifically, in a case of when the aggregate has an average particle size of between 1 μm and 100 μm, the external volume of the porous particles is rarely changed.

Further, since the porous particles are formed with a plurality of voids, the non-aqueous electrolyte is impregnated within the voids when it is used as the negative active material for a lithium rechargeable battery. Accordingly, the lithium ions can be introduced inside the porous particles, and lithium can effectively be diffused to achieve a high capacity.

Further, the negative active material for the lithium rechargeable battery according to the present invention is characterized in that the n/N ratio is between 0.001 and 0.2, wherein n is the average diameter of the void and N is the average particle size of the aggregate.

Because the n/N ratio of the negative active material for the lithium rechargeable battery is between 0.001 and 0.2, which means that the diameter of the voids with respect to the particle size of the porous particles is very small, the hardness of the porous particles is maintained, thereby preventing pulverization of the particles and changes in the external volume.

Further, the negative active material for the lithium rechargeable battery is characterized in that the volume ratio of the voids to the porous particles is between 0.1% and 80%.

Since the negative active material for the lithium rechargeable battery has a volume ratio of voids to porous particles of between 0.1% and 80%, the expansion and contraction of Si volume during intercalation and deintercalation of lithium ions is fully compensated by the voids, and the entire volume of the porous particles is maintained. Thereby, the hardness of the porous particles is not degenerated, and pulverization of the particles can be prevented.

Further, the negative active material for the lithium rechargeable battery according to the present invention is characterized in that a part of the porous particles is amorphous and the remaining part is crystalline.

Since a part of the negative active material for the lithium rechargeable battery is amorphous, the cycle characteristics of the battery including the negative active material are improved.

Further, the negative active material for the lithium rechargeable battery is characterized in that the porous particles are generated by quenching a molten metal alloy including Si and at least one element of Metal M to provide a quenched alloy, and eluting and removing the element M from the quenched alloy with an acid or an alkali.

According to the present invention, the porous particles are formed with very tiny voids provided at the portion where the element M is removed from the quenched alloy. However, all of element M may not be completely removed from the quenched alloy, and some of it may remain in the negative active material.

Further, the negative active material is characterized in that the content of the element M in the molten metal alloy is between 0.01% and 70% by weight. When the content of the element M is within this range, it is possible for the voids to have the above-stated average diameter and volume ratio ranges.

According to a further aspect of the present invention, a lithium rechargeable battery is characterized in that it includes the negative active material.

Therefore, because the lithium rechargeable battery includes the negative active material according to the present invention, pulverization of the negative active material is prevented, as is peeling of the negative active material from the current collector. It is also possible to maintain the bond of the negative active material with the conductive material. It is thereby possible to provide a lithium rechargeable battery having an improved charge and discharge capacity and an improved cycle characteristic.

According to a further aspect of the present invention, the method of preparing the negative active material for the lithium rechargeable battery is characterized in that it includes quenching a molten metal alloy including Si and at least one element M to provide a quenched alloy; and eluting and removing the element M from the quenched alloy with an acid or an alkali capable of dissolving the element M, to provide an aggregate of Si porous particles.

According to the method of preparing a negative active material for a lithium rechargeable battery of the present invention, it is possible to provide a Si-included porous particle formed with voids at portions where the element M is removed. The obtained voids have a very tiny average diameter, and are uniformly distributed through the whole porous particle. Therefore, volume expansion during intercalation of lithium ions to the Si is compensated by compressing the volume of the void so that the external volume of the porous particle is not remarkably changed.

When the element M is removed from the quenched alloy, the negative active material is mostly composed of Si, which facilitates bonding with lithium ions. It is thereby possible to increase the energy density per weight of a negative active material.

Due to quenching of the molten metal alloy, the resultant quenched alloy has an amorphous structure which facilitates intercalation with lithium in at least a part thereof, so the cycle characteristics are improved.

The resultant quenched alloy may have a crystalline phase composed of tiny crystal particles in the structure thereof. In this case, it is easy to remove the selected element M included in the crystalline phase. The voids obtained by eluting and removing the element M from the tiny crystalline phase and the amorphous phase can have a smaller average diameter than those obtained by eluting and removing the element M from the crystalline phase of a large crystal, and the voids can be uniformly distributed in the whole particle. When the voids have a large average diameter and are irregularly distributed in the whole particle, it is hard to have uniform effects of the whole particle upon the volume expansion of Si, and the hardness of the particle is degenerated. Consequently, the cycle characteristics are also degenerated.

The method of preparing the negative active material for the lithium rechargeable battery is characterized in that the molten metal alloy may be quenched by any one of a number of methods including gas atomizing, water atomizing, and roll quenching. The quenched alloy is easily prepared by using any one of these quenching methods.

The method of preparing the negative active material for the lithium rechargeable battery is also characterized in that the quenching rate of the molten metal alloy is more than 100 K/second. When the quenching rate is more than 100 K/second, a quenched alloy having at least a portion in the crystalline phase is easily provided. When the crystalline phase is generated in the structure, the crystal particles in the crystalline phase can be controlled to be small.

The method of preparing the negative active material for the lithium rechargeable battery is further characterized to include soaking the quenched alloy in an acid or alkali solution capable of dissolving the element M to elute and remove it; and washing and drying the quenched alloy. These steps render easy removal of the element M from the quenched alloy.

The content of the element M is between 0.01% and 70% by weight in the molten metal alloy. When the content of the element M is within the above range, the amount of element M is not so little that the number of voids is inadequate to compensate for the volume expansion, and the amount of element M is also prevented from being excessively large to a point whereby the average diameter of the voids is too large to maintain the hardness of the porous particles

Hereinafter, the present invention is described with reference to drawings.

According to the present invention, the negative active material for a lithium rechargeable battery includes an aggregate of Si porous particles, wherein the porous particles are formed with a plurality of voids having a diameter of between 1 nm and 10 μm, preferably between 10 nm and 1 μm, and more preferably between 50 nm and 0.5 μm; and the aggregate has an average particle size of between 1 μm and 100 μm.

The negative active material is applied to a negative electrode for the lithium rechargeable battery. When the lithium rechargeable battery is charged, lithium ions are transferred from the positive electrode to the negative electrode. During this process, the lithium ions are intercalated with the Si porous particles in the negative electrode. In the intercalation process, the volume of Si is expanded. During discharge, the lithium ions are deintercalated from the Si and transferred to the positive electrode, thereby contracting the expanded volume of the Si to as it was initially. When the charge and discharge are repeated, the volume of the Si is repeatedly expanded and contracted.

According to the negative active material of the present invention, since the porous particles are formed with a plurality of voids, the entire volume of the porous particles is externally maintained by compressing the void volume when the volume of Si is expanded by intercalation of lithium ions, so that the porous particles can be prevented from being pulverized.

Further, according to one embodiment of the present invention, the porous particles of the negative active material are prepared by the steps of: quenching a molten metal alloy including Si and at least one element M to generate a quenched alloy; and eluting and removing the element M with an acid or alkali solution. The element M is preferably selected from the group consisting of 2A, 3A, and 4A groups and transitional elements, and is more preferably selected from the group consisting of Sn, Al, Pb, In, Ni, Co, Ag, Mn, Cu, Ge, Cr, Ti, and Fe.

The porous particles according to the embodiment are prepared by eluting and removing the element M from the quenched alloy including Si and the element M. As a result, the quenched alloy has very tiny voids since the voids are generated at the portion where the element M is removed.

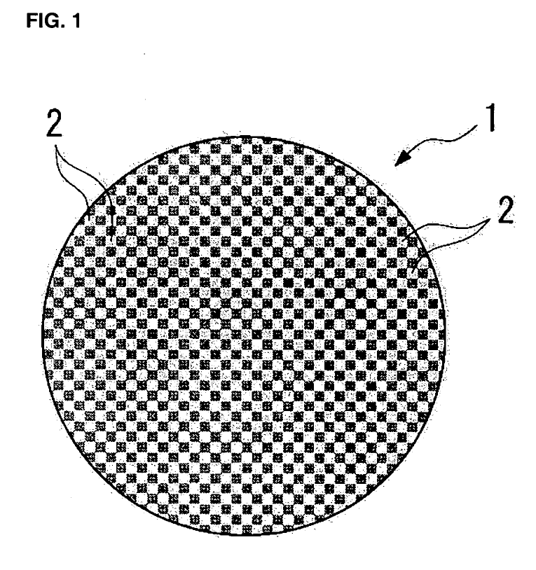

FIG. 1 is a cross-sectional view showing one embodiment of the porous particle. As shown in FIG. 1, a porous particle 1 is formed with a plurality of voids 2 and each void 2 has a relatively uniform shape.

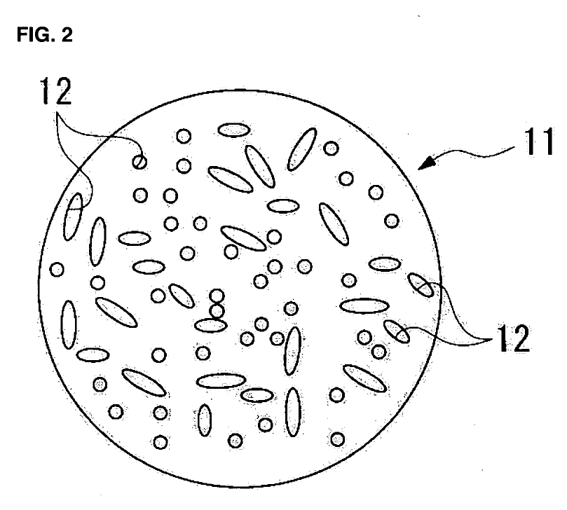

FIG. 2 is a cross-sectional view showing another embodiment of a porous particle. As shown in FIG. 2, although the porous particle 11 is also formed with a plurality of voids 12, the voids 12 have irregular shapes.

Further, the porous particles 1, 11, as shown in FIGS. 1 and 2, may be composed of amorphous Si in a part and crystalline Si in the remaining part. Alternatively, such porous particles 1, 11 may be entirely of a structure of a crystalline Si phase. The structure of the porous particles is determined when quenching the crystalline structure while the negative electrode is being prepared. When a part of the porous particles 1, 11 has an amorphous phase, it is possible to improve the cycle characteristics of the negative electrode.

Further, the average particle size of the porous particles 1, 11 is preferably between 1 μm and 100 μm. When the average particle size is less than him, the relative volume of the voids 2, 12 of the porous particles 1, 11 is excessively increased and the hardness of the porous particles 1, 11 is degenerated. In addition, when the average particle size is more than 100 μm, the volume variation of the porous particles 1, 11, of themselves, is too large to prevent pulverization of the particles.

The voids 2, 12 of the porous particles 1, 11 have an average diameter of between 1 nm and 10 μm, preferably between 10 nm and 1 μm, and more preferably between 50 nm and 0.5 μm.

Specifically, the void 2 of the porous particle 1 shown in FIG. 1 has a average diameter of between 10 nm and 0.5 μm. In addition, the void 12 of the porous particle 11 shown in FIG. 2 has an average diameter of between 200 nm and 2 μm, which is larger than the void shown in FIG. 1.

When the average diameter of the voids 2, 12 is less than 1 nm, the volume of the voids 2, 12 is too small to compensate for the expansion volume of Si generated when Si is intercalated with lithium ions, so the entire size of the porous particles 1, 11 is externally changed, and the porous particles 1, 11 may be pulverized. When the average diameter of the voids 2, 12 is more than 10 μm, it is also disadvantageous since the total volume of the voids is excessively increased so that the hardness of the porous particles themselves are degenerated.

Further, the n/N ratio is preferable between 0.001 and 0.2, wherein n is an average diameter of the voids 2, 12, and N is an average particle size of the porous particles 1, 11. When the n/N ratio is within this range, the diameter of the voids 2, 12 compared to the average particle size of the porous particles 1, 11 is so small that the hardness of the porous particles can be maintained and pulverization of the particles is prevented regardless of the volume variation.

When the n/N ratio is less than 0.001, the relative diameter of the voids 2, 12 is too small to compensate for the volume expansion of the Si upon intercalation of Si with lithium ions. Further, when the n/N ratio is more than 0.2, it is also disadvantageous since the hardness of the porous particles 1, 11 is reduced so that the particles are pulverized.

The void fraction per volume of the porous particles 1, 11 is between 0.1% and 80%, preferably between 0.1 and 50%, and more preferably between 0.1% and 30%. As long as the void fraction is within the range, the volume expansion of Si generated upon intercalation of Si with lithium ions can be compensated by the void, the volume of the porous particles is not externally changed, and the hardness of the porous particles is not degenerated which prevents pulverization of the particles.

A void fraction less than 0.1% is undesirable because the volume expansion of Si generated upon alloying with lithium can not be compensated with the voids. When the void fraction is more than 80%, it is also disadvantageous since the hardness of the porous particles 1, 11 is too degenerated to prevent pulverization of the particles.

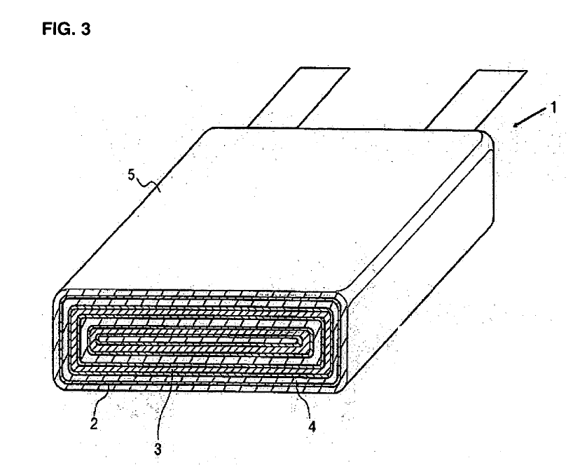

According to one embodiment of the present invention as shown in FIG. 3, the lithium rechargeable battery essentially consists of at least a negative electrode 21 including the negative active material, a positive electrode 23, and an electrolyte 25.

The negative electrode may be fabricated, for example, by solidifying the negative active material of the aggregate into a sheet shape by adding a binder. The binder binds the aggregate of ultra-fine particles.

The aggregate may be solidified into a pellet having a columnar, discoid, lamellar, or cylindrical shape.

While the binder may be composed of either an organic or an inorganic material, it should be distributed and dissolved in a solvent together with the porous particles and bind each of the porous particles after removing the solvent. Alternatively, it may be one capable of being solidified by, for example, press solidification, together with the ultra-fine particles, and binding each into the aggregate. Such binder may include a vinyl-based resin, a cellulose-based resin, a phenyl resin, a thermoplastic resin, a thermosetting resin, or similar resins. Examples include polyvinylidene fluoride, polyvinylalcohol, carboxymethyl cellulose, or butylbutadiene rubber.

The negative electrode of the present invention may further include a conductive agent such as carbon black, in addition to the negative active material and the binder.

The positive electrode includes a positive active material capable of intercalating and deintercalating lithium ions. Positive active materials include organic disulfide compounds and organic polysulfide compounds such as LiMn₂O₄, LiCoO₂, LiNiO₂, LiFeO₂, V₂O₅, TiS, and MoS.

The positive electrode may further include a binder such as polyvinylidene fluoride, and a conductive agent such as carbon black.

The positive electrode and the negative electrode may be respectively fabricated by coating the positive electrode or the negative electrode on a current collector of a metal foil to form a sheet.

The electrolyte may include an organic electrolyte capable of dissolving the lithium salt in a non-protonic solvent. The non-protonic solvent may include, but is not limited to, propylene carbonate, ethylene carbonate, butylene carbonate, benzonitrile, acetonitrile, tetrahydrofuran, 2-methyl tetrahydrofuran, v-butyrolactone, dioxolan, 4-methyl dioxolan, N,N-dimethyl formamide, dimethyl acetamide, dimethyl sulfoxide, dioxane, 1,2-dimethoxyethane, sulfolane, dichloroethane, chlorobenzene, nitroheptane, dimethylcarbonate, methyl ethyl carbonate, diethylcarbonate, methylpropyl carbonate, methyl isopropyl carbonate, ethyl butyl carbonate, dipropyl carbonate, diisopropyl carbonate, dibutyl carbonate, diethylene glycol, or dimethyl ether, or a mixture thereof. Preferably, it includes any one of propylene carbonate, ethylene carbonate (EC), butylene carbonate, dimethyl carbonate (DMC), methylethyl carbonate (MEC), or diethyl carbonate (DEC).

Examples of the lithium salt include LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlCI₄, LiN(CₓF₂ₓ₊₁SO₂)(C_{y}F_{2y+1}SO₂) (wherein x and y are natural numbers), LiCl, Lil, or mixtures thereof, and preferably it includes either one of LiPF₆ or LiBF₄.

In addition, the electrolyte may include any conventional organic electrolyte known for fabricating a lithium battery.

The electrolyte may also include a polymer electrolyte in which the lithium salt is mixed with a polymer such as PEO or PVA, or one in which an organic electrolyte is impregnated in a high-swelling polymer.

According to the present invention, the lithium rechargeable battery may further include material other than the positive electrode, the negative electrode, and the electrolyte. For example, a separator separating the positive electrode from the negative electrode may be included.

According to the present invention, since the lithium rechargeable battery includes the negative active material according to the present invention, it is possible to prevent pulverization of the negative active material and peeling of the active material from the current collector. Further, the negative active material may be bound with a conductive material so that it is possible to improve the charge and discharge capacities and the cycle characteristics.

In addition, since the porous particles are formed with a plurality of voids, when they are applied to the negative electrode for the lithium rechargeable battery, the voids can be accommodated with a non-aqueous electrolyte to introduce the lithium ions into the inside of the porous particles so that the lithium ions can effectively be diffused. As a result, it is possible to achieve high charge and discharge capacities.

Hereinafter, the method of preparing a negative active material for a lithium rechargeable battery is described in detail.

The method of preparing the negative active material for the lithium rechargeable battery includes obtaining a quenched alloy including Si and the element M; and eluting the obtained quenched alloy. Now, each process will be described in order.

Firstly, the quenched alloy is obtained by quenching a molten metal alloy including Si and the element M. The molten alloy includes Si and at least one element M, the element M preferably being selected from the group consisting of 2A, 3A, and 4A groups and transition metal groups, and more preferably at least one element M selected from the group consisting of Sn, Al, Pb, In, Ni, Co, Ag, Mn, Cu, Ge, Cr, Ti, and Fe. The molten alloy may by obtained by high frequency induction heating of any one or an alloy of the above elements M at the same time.

The content of the element M is preferably between 0.01% and 70% by weight. When the content of element M is present within the above range, the resultant average diameter of the voids is neither excessively small nor large.

The method of quenching the metal alloy may include gas atomizing, water atomizing, roll quenching, and other methods. A powdery quenched alloy is prepared by the gas atomizing and the water atomizing methods, while a thin-film quenched alloy is prepared by the roll quenching method. The thin-film quenched alloy may be further pulverized to obtain a powder. The average diameter of such obtained powdery quenched alloy is determined as a final average diameter of the porous aggregate. Accordingly, the average particle size of the powdery quenched alloy is controlled to between 1 μm and 100 μm.

The quenched alloy obtained from the molten metal alloy may have a structure that is entirely amorphous; a structure in which a part is amorphous and a remaining part is of a fine crystalline structure; or a structure that is entirely crystalline.

The amorphous structure is mainly composed of an alloy of Si and the element M, while the crystalline structure is composed of any one phase of an alloy of the element M and Si, a Si single phase, and an element M single phase. Accordingly, the quenched alloy may include at least one of an amorphous phase of the alloy of Si and the element M, a crystalline phase of the alloy of Si and the element M, a crystalline phase of the Si single phase, or a crystalline phase of the element M single phase. Si is alloyed with the element M in a ratio such that neither a Si single phase nor an element M single phase is formed. The crystalline phase is composed of fine crystal particles having an average particle size of between several and several tens of nm. Such fine crystal particles may be obtained by quenching the molten metal alloy.

The quenching rate is preferable at least 100 K/second. When the quenching rate is less than 100 K/second, the crystal particles are excessively large, resulting in generation of a void having an excessively large diameter.

Subsequently, the quenched alloy is subjected to the elution and removal process of the element M by an acid or alkali solution.

Specifically, the powdery quenched alloy is soaked in the acid or alkali solution capable of eluting the element M, and is then washed and dried. When eluting the element M, it is preferably carried out while heating at 30 to 60° C. and agitating, for 1 to 5 hours.

The acid to be used for eluting the element M is determined depending upon the kind of element M, but it is preferably hydrochloric acid or sulfuric acid. Similarly, the alkali to be used for eluting the element M is determined depending upon the kind of the element M, but it is preferable sodium hydroxide or potassium hydroxide. Further, the acid or alkali selected should not corrode Si.

The porous particles of Si are prepared by eluting the element M from the quenched alloy to provide a void at a portion where the element M is removed.

As described above, the quenched alloy includes at least one of an amorphous alloy phase of Si and the element M, a crystal alloy phase, a crystal single phase of Si, and a crystal single phase of the element M.

When the element M is eluted and removed from the quenched alloy having such structure, the alloy phase becomes Si single phase because the element M single phase is removed. Consequently, the quenched alloy powder after eluting the element M includes at least one phase of an amorphous Si single phase or a crystal Si single phase. Even though the single phase of the element M is removed from the quenched alloy, a trace amount of the single phase of the element M may remain in the negative active material.

As shown in FIG. 1, the single phase of Si, which is obtained by removing the element M from the amorphous alloy phase, has a uniform cross-sectional void distribution, and the voids 2 have regular diameters. On the other hand, as shown in FIG. 2, when the single phase of the element M is completely removed from the crystal phase, the porous particle has an irregular cross-sectional void distribution, and the voids 12 have irregular diameters. The voids 2, 12 have average diameters of between 1 nm and 10 μm.

According to the method of preparing the negative active material of the present invention, the element M is eluted and removed from the quenched alloy including Si and the element M, and voids are generated at the portion where the element M is removed to provide a porous particle of Si. The obtained voids have very tiny diameters and are distributed on the porous particles. It is therefore possible to provide a porous particle in which the volume of the voids is compressed when the volume is expanded by intercalating lithium ions with Si, and in which the external volume is not significantly changed.

Further, as most of the structure of the porous particle is composed of Si capable of easily intercalating and deintercalating lithium ions, it is possible to provide a negative active material having a high energy density per weight.

Further, as at least a part of the quenched alloy is constructed of an amorphous phase, it is possible to improve the cycle characteristics.

When the structure of the quenched alloy includes tiny crystal particles, it is possible to facilitate eluting and removing the element M only included in the crystal phase.

An example of a lithium-sulfur battery according to the invention is shown in FIG. 3. The lithium-sulfur battery 1 includes a positive electrode 3, a negative electrode 4, and a separator 2 interposed between the positive electrode 3 and the negative electrode 4. The positive electrode 3, the negative electrode 4, and the separator 2 are contained in a battery case 5. The electrolyte is present between the positive electrode 3 and the negative electrode 4.

The following examples further illustrate the present invention in detail but are not to be construed to limit the scope thereof.

Preparation of a Negative Active Material

### EXAMPLE 1

50 parts by weight of Si ingots having a 5 mm corner size and 50 parts by weight of Ni powder were mixed and melted under an Ar atmosphere with high frequency heating to provide a molten metal alloy. The molten metal alloy was quenched by the gas atomizing method using helium gas at a pressure of 80 kg/cm² to provide a quenched alloy powder having an average particle size of 9 μm. The quenching rate was 1×10⁵ K/second. X-ray diffraction of the resultant powder showed that a crystal phase and an amorphous phase consisting of NiSi₂ coexisted in the alloy phase.

The obtained quenched alloy powder was added to diluted nitric acid, agitated at 50° C. for 1 hour, and subsequently completely washed and filtered. It was then dried in a furnace at 100° C. for 2 hours, thereby obtaining the negative active material of Example 1.

### EXAMPLE 2

A negative active material of Example 2 was prepared in the same manner as in Example 1, except that 80 parts by weight of Si and 20 parts by weight of Ni were used.

It was observed that the quenched alloy powder had a structure of a Si single phase, and an amorphous and a crystal alloy phase of NiSi₂.

The reason that both a Si single phase and a NiSi₂ alloy phase were detected is believed to be that the amount of Si was significantly more than that of Ni, so that some Si alloyed with Ni and an excess of Si was deposited as a Si single phase.

### EXAMPLE 3

70 parts by weight of Si lumps having a 5 mm corner size and 30 parts by weight of Al powder were mixed and melted under an Ar atmosphere with high frequency heating to provide a molten metal alloy. The molten metal alloy was quenched by the gas atomizing method using helium gas at a pressure of 80 kg/cm² to provide a quenched alloy powder having an average particle size of 10 μm. A crystal Al single phase and a crystal Si single phase were observed by X-ray diffraction analysis of the resultant powder.

The obtained quenched alloy powder was added to an aqueous solution of hydrochloric acid, agitated at 50° C. for 4 hours, and subsequently completely washed and filtered. It was then dried in a furnace at 100° C. for 2 hours, thereby obtaining the negative active material of Example 3.

### EXAMPLE 4

A negative active material of Example 4 was prepared in the same manner as in Example 3, except that sulfuric acid was used instead of hydrochloric acid.

### COMPARATIVE EXAMPLE 1

50 parts by weight of Si lumps having a 5 mm corner size and 50 parts by weight of Ni powder were mixed and melted under an Ar atmosphere with high frequency heating to provide a molten metal alloy. The molten metal alloy was quenched by the gas atomizing method using helium gas at a pressure of 80 kg/cm² to provide a quenched alloy power having an average particle size of 9 μm. The resultant powder was obtained as a negative active material of Comparative Example 1. The alloy phase had a coexisting crystal phase and amorphous phase of NiSi₂, determined through X-ray diffraction of the resultant powder.

### COMPARATIVE EXAMPLE 2

50 parts by weight of Si ingots having a 5 mm angle size and 50 parts by weight of Al powder were mixed and solidified into a pellet. The pellet was placed in a furnace and melted under an Ar atmosphere at 1600° C. and spontaneously cooled to provide an ingot. The ingot was ground to provide a powder having an average particle size of 20 μm.

The obtained powder was then added to diluted nitric acid, agitated at 50° C. for 1 hour, and subsequently completely washed and filtered. It was then dried in a furnace at 100° C. for 2 hours, to obtain the negative active material of Comparative Example 2.

Preparation of a Lithium cell

70 parts by weight of each negative active material obtained from Examples 1 to 4 and Comparative Examples 1 to 3 were individually added to 20 parts by weight of a graphite powder having an average particle size of 2 μm as a conductive material, 10 parts by weight of polyvinylidene were mixed therein, and N-pyrrolidone was added thereto and agitated to provide slurries. Each slurry was coated on an Al foil having a thickness of 14 μm and dried. Then, the slurry-coated Al foils were rolled to provide 80 μm thick negative electrodes, which were cut in circles having a diameter of 13 mm. Each negative electrode was placed in a can with a polypropylene separator, the lithium metal counter electrode, and an electrolyte of 1 mole/L of LiPF₆ in a mixed solution of EC:DMC:DEC (3:1:1 volume ratio) to prepare coin-type lithium half cells.

The resultant lithium rechargeable cells were subjected to repeated charge and discharge at a voltage of 0 to 1.5 V and a current density of 0.2 C for 30 cycles.

### Properties of the Negative Active Materials of Examples 1 to 4

The negative active material of Example 1 was observed by electron microscope. According to the observation, a porous particle was found and voids having relatively regular cross-sectional shapes were formed in the porous particle, as shown in FIG. 1. The average diameter of the voids was between 200 and 500 nm. The porous particle was subjected to atomic analysis using an energy-diffusing X-ray analyzer. The results showed that Ni was found on both the surface and the cross section of the porous particle.

Accordingly, it was found that, after eluting and removing Ni with the hydrochloric acid, uniform voids were generated.

Subsequently, the negative active material of Example 2 was observed by electron microscope. According to the observation, a porous particle was found, and voids having relatively irregular cross-sectional shapes were formed in the porous particle, as shown in FIG. 2. The average diameter of the voids was between 200 nm and 2 μm, which is larger than that of Example 1. The porous particle was subjected to atomic analysis using an energy-diffusing X-ray analyzer. The results showed that Ni was not found on the surface nor in the cross section of the porous particle.

Accordingly, it is considered that the irregularly shaped voids were obtained because the quenched alloy powder was formed of different structures, and the Ni of the NiSi₂ alloy phase was eluted and removed from the quenched alloy powder composed of the Si single phase and the NiSi₂ alloy phase.

Further, the negative active material of Example 3 was observed by electron microscope. According to the observation, a porous particle was found, and voids having relatively irregular cross-sectional shapes were formed on the porous particle, as shown in FIG. 2. The average diameter of the voids was between 300 nm and 2 μm, which is larger than that of Example 1. The porous particle was subjected to atomic analysis using an energy-diffusing X-ray analyzer, and the results showed that Al was not found on either the surface nor on the cross section of the porous particle.

Accordingly, it is considered that the irregularly shaped voids were obtained because the Al single phase was eluted and removed from the quenched alloy powder composed of the Si single phase and the Al single phase.

Finally, the negative active material of Example 4 was found to have voids with irregular diameters. The range of the average diameter of the voids was the same as in the case of Example 3. Results of atomic analysis showed that Al was not found, and it is believed that Al can be removed by treating with sulfuric acid.

Properties of a Lithium Rechargeable Battery

The capacity retention of the discharge capacity at the 30th cycle to the discharge capacity at the first cycle is shown in Table 1:

TABLE 1

| | Capacity retention (%) |
|---|---|
| Example 1 | 95 |
| Example 2 | 85 |
| Example 3 | 83 |
| Example 4 | 83 |
| Comparative Example 1 | 45 |
| Comparative Example 2 | 28 |
| Comparative Example 3 | 20 |

The lithium rechargeable cells according to the Examples 1 to 4 had good capacity-maintaining ratios of between 83 and 95%. On the other hand, those of Comparative Examples 1 to 3 had low capacity-maintaining ratios of between 20 and 45%.

As the negative active material of Comparative Example 1 was not subjected to the elution treatment of Ni, the particles constructing the negative active material powder were not formed with voids. Therefore, the volume variations of the negative electrode were larger as the charge and discharge processes were repeated, pulverizing the particles. As a result, the capacity-maintaining ratio was degenerated.

Further, as the negative active material of Comparative Example 2 was subjected to the spontaneous cooling treatment instead of the quenching treatment, the resultant alloy had exaggerated crystal particles, so the void diameters increased. The hardness of the negative active material powder was consequently degenerated, and the negative active material was pulverized as the charge and discharge processes were repeated. As a result, the capacity-maintaining ratio was degenerated.

Finally, as the negative active material of Comparative Example 3 was composed of only a Si powder, the volume variation of the resultant negative active material was increased and the negative active material was pulverized as the charge and discharge processes were repeated. As a result, the capacity-maintaining ratio was degenerated.

As described in the above, the negative active materials according to Examples 1 to 4 were prepared by providing the quenched alloy via a gas atomizing process, and eluting and removing the element M. Therefore, the cycle characteristics compared to those of Comparative Examples 1 to 3 were improved. The void shape and final battery properties were remarkably affected by the structure of the quenched alloy before subjecting them to the eluting and removing processes in the negative active materials according to Examples 1 to 4.

That is, the element M to be removed was alloyed with Si to generate uniform and tiny voids. The voids could therefore compensate the volume variation upon charge and discharge. As the size of the voids increased, the hardness of the particle somewhat degenerated. Further, the electrolyte is easily impregnated into the voids of the porous particles, and lithium ions are also easily diffused to improve the battery properties.

As described above, in the negative active material according to the present invention, when the porous particle is formed with a plurality of voids, the external volume thereof is rarely changed because the volume of the voids is compressed when the volume is expanded upon intercalation of Si with lithium ions. Pulverization of the porous particle is thereby prevented.

Particularly, when the average particle size of the aggregate is within the range of 1 μm to 100 μm, the external volume is not changed.

Further, as the porous particle is formed with a plurality of voids, the non-aqueous electrolyte can be impregnated into the voids, and thereby the lithium ions are introduced inside of the porous particle to more effectively diffuse. As a result, it is possible to achieve high rate charge and discharge.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A negative active material for a lithium rechargeable battery, comprising:
an aggregate of Si porous particles, wherein the porous particles are formed with a plurality of voids therein, wherein the voids have an average diameter of between 1 nm and 10 μm, and the aggregate has an average particle size of between 1 μm and 100 μm.

2 The negative active material for a lithium rechargeable battery according to claim 1, wherein the average diameter of the voids is between 10 nm and 1 μm.

3. The negative active material for a lithium rechargeable battery according to claim 2, wherein the average diameter of the voids is between 50 nm and 0.5 μm.

4. The negative active material for a lithium rechargeable battery according to claim 1, wherein an n/N ratio of the voids is between 0.001 and 0.2, wherein n is an average diameter of the voids and N is an average particle size of the aggregate.

5. The negative active material for a lithium rechargeable battery according to claim 1, wherein a void fraction per volume of the porous particles is between 0.1% and 80%.

6. The negative active material for a lithium rechargeable battery according to claim 5, wherein the void fraction per volume of the porous particles is between 0.1% and 50%.

7. The negative active material for a lithium rechargeable battery according to claim 6, wherein the void fraction per volume of the porous particles is between 0.1% and 30%.

8. The negative active material for a lithium rechargeable battery according to claim 1, wherein the porous particles have a structure in which a part is an amorphous phase and the remaining part is a crystal phase.

9. The negative active material for a lithium rechargeable battery according to claim 1, wherein the porous particles are prepared by quenching a molten alloy comprising Si and at least one of an element M, and eluting and removing the element M with an acid or an alkali.

10. The negative active material for a lithium rechargeable battery according to claim 9, wherein the element M is selected from the group consisting of 2A, 3A, and 4A groups, transition metal groups and combinations thereof.

11. The negative active material for a lithium rechargeable battery according to claim 10, wherein the element M is selected from the group consisting of Sn, Al, Pb, In, Ni, Co, Ag, Mg, Cu, Ge, Cr, Ti, Fe and combinations thereof.

12. The negative active material for a lithium rechargeable battery according to claim 9, wherein the content of the element M is between 0.01% and 70% by weight.

13. The negative active material for a lithium rechargeable battery according to claim 1, wherein the negative active material further comprises at least one of an element M.

14. The negative active material for a lithium rechargeable battery according to claim 13, wherein the element M is selected from the group consisting of 2A, 3A, and 4A groups, transition metal groups and combinations thereof.

15. The negative active material for a lithium rechargeable battery according to claim 14, wherein the element M is selected from the group consisting of Sn, Al, Pb, In, Ni, Co, Ag, Mg, Cu, Ge, Cr, Ti, Fe and combinations thereof.

16. A lithium rechargeable battery comprising
a negative electrode comprising a negative active material comprising an aggregate of Si porous particles, wherein the porous particles are formed with a plurality of voids therein, wherein the voids have an average diameter of between 1 nm and 10 μm, and the aggregate has an average particle size of between 1 μm and 100 μm;
a positive electrode; and
an electrolyte.

17. A method of preparing a negative active material for a lithium rechargeable battery, comprising:
quenching a molten metal alloy comprising Si and at least one of an element M to provide a quenched alloy; and
eluting and removing the element M from the quenched alloy with an acid or an alkali capable of dissolving the element M to provide an aggregate of porous particles comprising Si.

18. The method of preparing the negative active material for a lithium rechargeable battery according to claim 17, wherein the element M is selected from the group consisting of 2A, 3A, and 4A groups, transition metal groups and combinations thereof.

19. The method of preparing the negative active material for a lithium rechargeable battery according to claim 18, wherein the element M is selected from the group consisting of Sn, Al, Pb, In, Ni, Co, Ag, Mg, Cu, Ge, Cr, Ti, Fe and combinations thereof.

20. The method of preparing the negative active material for a lithium rechargeable battery according to claim 17, wherein the molten metal alloy is quenched by a process selected from the group consisting of gas atomizing processes, water atomizing processes, and roll quenching processes.

21. The method of preparing the negative active material for a lithium rechargeable battery according to claim 17, wherein the molten metal alloy is quenched at a rate of at least 100 K/second.

22. The method of preparing the negative active material for a lithium rechargeable battery according to claim 17, wherein the quenched alloy is impregnated in an acid or alkali solution capable of dissolving the element M to elute and remove the element M, and is then washed and dried.

23. The method of preparing the negative active material for a lithium rechargeable battery according to claim 17, wherein the content of the element M is between 0.01% and 70% by weight.
